(19) United States
(12) Patent Application Publication
(10) Pub. No.: US 2025/0204302 A1
(43) Pub. Date: Jun. 26, 2025

(54) AGRICULTURAL PLANTING IMPLEMENT WITH SEED TO GROUND SYSTEM

(71) Applicant: Kinze Manufacturing, Inc., Williamsburg, IA (US)

(72) Inventors: Matthew Wilhelmi, Williamsburg, IA (US); Ryan Veatch, Williamsburg, IA (US)

(21) Appl. No.: 18/989,319

(22) Filed: Dec. 20, 2024

Related U.S. Application Data
(60) Provisional application No. 63/612,787, filed on Dec. 20, 2023.

(51) Int. Cl. A01C 7/16

(52) U.S. Cl. CPC A01C 7/16

(57) ABSTRACT

A seed to ground system for a row unit of an agricultural planting implement includes a housing. An impeller-like member is rotated in the housing to move seed from an upper end to a lower end. A series of floors are vertically spaced to control the speed of the seed moved by the rotating impeller as well. The seed is delivered to a rotating wheel at a lower end of the housing. The rotating wheel is rotated at a speed to substantially match the ground speed of the planting implement so that the seed that is delivered to and from the wheel will be dispensed with substantially zero net horizontal velocity into a furrow in the field.

### CROSS REFERENCE TO RELATED APPLICATIONS

This application claims priority under 35 U.S.C. § 119 to provisional patent application U.S. Ser. No. 63/612,787, filed Dec. 20, 2023. The provisional patent application is herein incorporated by reference in its entirety, including without limitation, the specification, claims, and abstract, as well as any figures, tables, appendices, or drawings thereof.

### TECHNICAL FIELD

The present disclosure relates generally to agricultural planting implements. More particularly, but not exclusively, the disclosure includes aspects and/or embodiments of agricultural implements having a controlled system for transporting seed from a seed meter to a furrow in the ground to be able to better match the ground speed of the implement.

### BACKGROUND

The background description provided herein gives context for the present disclosure. Work of the presently named inventors, as well as aspects of the description that may not otherwise qualify as prior art at the time of filing, are neither expressly nor impliedly admitted as prior art.

An agricultural row crop planter is a machine built for distributing seed to the ground. The row crop planter generally includes a horizontal toolbar fixed to a hitch assembly for towing behind a tractor or other vehicle. Row units are mounted to the toolbar and spaced according to the desired spacing between rows of crops to be planted. In different configurations, seed may be stored at individual hoppers on each row unit, or it may be maintained in a central hopper and delivered to the row units on an as needed basis. The row units include ground-working tools for opening and closing a seed furrow, and a seed metering system for distributing seed to the seed furrow.

In its most basic form, the seed meter includes a housing and a seed disc. Seed is introduced into the housing, such as at a seed pool location. The seed disc resides within the housing and rotates. As the seed disc rotates, it passes through the seed pool where it picks up individual seeds. The seeds can be picked up at seed cells of the disc. This can be done with a pressure differential (e.g., positive or negative pressure) at the seed cells, or with a finger that can be manipulated to hold a seed in place during rotation of the disc. The seeds are carried by the disc and subsequently dispensed from the seed meter and transported to the seed furrow.

Seed spacing in the seed furrow is roughly controlled by varying the rotational speed of the seed disc. The most common seed delivery system for delivering seed from the seed disc to the furrow may be categorized as a gravity drop system. In the case of the gravity drop system, a seed tube has an inlet end, which is positioned below the seed meter. The singulated seeds from the seed meter drop into the seed tube and fall via gravitational force from a discharge end thereof into the seed furrow. Monitoring systems are commonly used to monitor the operation of the planter. Such systems typically employ a seed sensor attached to each seed tube to detect the passage of seed therethrough.

However, such a gravity system does not always result in absolute spacing. For example, as the spacing of the speed is dependent on the rotational velocity of the seed disc and the gravitational constant, interruptions, forces, or other occurrences acting on the seed, the row unit, or the planter itself can greatly affect the spacing. For example, if the seed bumps against a wall of the seed tube on the way to the furrow; this can cause a delay or a non-vertical fall of the seed. If a preceding or following seed does not experience the same interruption, the seeds could be spaced too close or far from one another.

Furthermore, as the speed of planting increases, this causes additional problems. Drawing a planting implement through the field at faster speeds requires increasing the speed of deposited seeds relative to the ground, causing seeds to roll and bounce upon landing in the trench or furrow and resulting in inconsistent plant spacing. The adverse agronomic effects of poor seed placement and inconsistent plant spacing are well known in the art.

Some attempts have been made, such as providing gripping or capturing of seed from the meter to the furrow in order to dictate spacing. Such systems use a brush belt that grip the seed and the speed of the belt is made to match the ground speed of the planter to release the seed with zero horizontal velocity to reduce roll. However, brush bristles can become damaged, especially when moving seed about the full length of a housing between the seed meter and the discharge location. In addition, it can be difficult for the brush belt to grip and capture the seed at the meter.

Thus, there exists a need in the art for an apparatus and/or system that overcomes and/or improves on the art.

### SUMMARY

The following objects, features, advantages, aspects, and/or embodiments, are not exhaustive and do not limit the overall disclosure. No single embodiment need provide each and every object, feature, or advantage. Any of the objects, features, advantages, aspects, and/or embodiments disclosed herein can be integrated with one another, either in full or in part.

It is a primary object, feature, and/or advantage of any of the aspects and/or embodiments of the present disclosure to improve on or overcome the deficiencies in the art.

It is a further object, feature, and/or advantage of any of the aspects and/or embodiments of the present disclosure to provide an agricultural planter with a seed delivery apparatus to provide consistent spacing between adjacent seed.

It is still yet a further object, feature, and/or advantage of any of the aspects and/or embodiments of the present disclosure to provide seed to a seed furrow in desired spacing at higher speeds. For example, higher speeds may be considered 5-15 miles per hour (MPH).

It is yet another object, feature, and/or advantage of any of the aspects and/or embodiments of the present disclosure to deliver seed to a seed furrow in a field with a net zero horizontal velocity.

The systems and/or apparatus disclosed herein can be used in a wide variety of applications. For example, it should be noted that agricultural planting implements are used to plant a variety of seed types, which relate to different crops. The system is able to deliver different seed types and sizes.

It is preferred the apparatus be safe, cost effective, and durable. For example, the systems and/or apparatus can be adapted to resist excessive heat, static buildup, corrosion, and/or mechanical failures (e.g., cracking, crumbling, shearing, creeping) due to excessive impacts and/or prolonged exposure to tensile and/or compressive forces.

At least one embodiment disclosed herein comprises a distinct aesthetic appearance. Ornamental aspects included in such an embodiment can help capture a consumer's attention and/or identify a source of origin of a product being sold. Said ornamental aspects will not impede functionality of the system.

Methods can be practiced which facilitate use, manufacture, assembly, maintenance, and repair of systems or apparatus which accomplish some or all of the previously stated objectives.

The systems or apparatus can be incorporated into systems or kits which accomplish some or all of the previously stated objectives. For example, it should be noted that the seed to ground systems can be part of an original implement or can be part of retrofit systems that are added after the fact.

According to some aspects of the present disclosure, an agricultural planting implement comprises a plurality of row units, each of the plurality of row units including a seed meter; and a seed to ground system, the seed to ground system comprising a housing with an upper end to receive seed from the seed meter and a lower end; one or more impellers rotatably mounted in the housing; one or more vertically spaced floors in the housing; and a delivery wheel at the lower end of the housing to receive seed and to eject seed with zero net horizontal velocity.

According to at least some aspects of some embodiments of the present disclosure, the one or more vertically spaced floors extend substantially perpendicular to an axis of the one or more impellers.

According to at least some aspects of some embodiments of the present disclosure, the one or more vertically spaced floors are positioned between sections of the one or more impellers.

According to at least some aspects of some embodiments of the present disclosure, the one or more impellers comprises sections, and each section comprises a portion of an impeller flighting around a center shaft.

According to at least some aspects of some embodiments of the present disclosure, additional features include an impeller motor operatively connected to the one or more impellers to provide rotation thereto, the impeller motor comprising an electric motor.

According to at least some aspects of some embodiments of the present disclosure, additional features include a wheel motor operatively connected to the delivery wheel, the wheel motor comprising an electric motor.

According to at least some aspects of some embodiments of the present disclosure, the delivery wheel comprises a brush wheel.

According to at least some aspects of some embodiments of the present disclosure, the wheel comprises a resilient material.

According to at least some aspects of some embodiments of the present disclosure, additional features include a wheel housing extending from the housing of the seed to ground system and covering a portion of the delivery wheel.

According to at least some aspects of some embodiments of the present disclosure, the wheel housing includes a discharge ramp for ejecting the seed.

According to additional aspects of the present disclosure, a row unit for use with an agricultural implement comprises a seed meter; a seed to ground system adjacent the seed meter and comprising a housing having an upper end to receive seed from the seed meter, a plurality of impellers and one or more floors in the housing, and a delivery wheel at a lower end of the housing to move seed from the housing to a furrow in a field.

According to at least some aspects of some embodiments of the present disclosure, the one or more floors in the housing are vertically spaced from one another.

According to at least some aspects of some embodiments of the present disclosure, the one or more floors are positioned between discontinuous flighting of the plurality of impellers.

According to at least some aspects of some embodiments of the present disclosure, additional features include an impeller motor operatively connected to the plurality of impellers to provide rotation thereto, the impeller motor comprising an electric motor.

According to at least some aspects of some embodiments of the present disclosure, additional features include a shaft connected to the impeller motor, and wherein the plurality of impellers is mounted on the shaft for rotation.

According to at least some aspects of some embodiments of the present disclosure, the delivery wheel comprises a brush wheel.

According to at least some aspects of some embodiments of the present disclosure, the brush wheel is operatively connected to an electric wheel motor.

According to at least some aspects of some embodiments of the present disclosure, additional features include a sensor in the housing.

These and/or other objects, features, advantages, aspects, and/or embodiments will become apparent to those skilled in the art after reviewing the following brief and detailed descriptions of the drawings. The present disclosure encompasses (a) combinations of disclosed aspects and/or embodiments and/or (b) reasonable modifications not shown or described.

### BRIEF DESCRIPTION OF THE DRAWINGS

Several embodiments in which the present disclosure can be practiced are illustrated and described in detail, wherein like reference characters represent like components throughout the several views. The drawings are presented for exemplary purposes and may not be to scale unless otherwise indicated.

FIG. 1 is a perspective view of an agricultural planting implement.

FIG. 2 is a side sectional view of a row unit used with planting implements and including aspects of the present disclosure.

FIG. 3 is a perspective view of a seed to ground system according to aspects of the present disclosure.

FIG. 4 is another perspective view of the seed to ground system.

FIG. 5 is a side elevation view of the seed to ground system.

FIG. 6 is an opposite side elevation view of the seed to ground system.

FIG. 7 is a rear elevation view of the seed to ground system.

FIG. 8 is a front elevation view of the seed to ground system.

FIG. 9 is a sectional view of the seed to ground system taken along lines A-A in FIG. 8 and showing aspects of the present disclosure.

FIG. 10 is an exploded view of the seed to ground system.

FIG. 11 is an enlarged view of a portion of the seed to ground system according to aspects of the present disclosure.

FIG. 12 is an elevation view showing the seed to ground system with portions of a housing removed.

FIG. 13 is an enlarged sectional view of a portion of the seed to ground system showing internal components thereof.

An artisan of ordinary skill in the art need not view, within isolated figure(s), the near infinite distinct combinations of features described in the following detailed description to facilitate an understanding of the present disclosure.

### DETAILED DESCRIPTION

Unless defined otherwise, all technical and scientific terms used above have the same meaning as commonly understood by one of ordinary skill in the art to which embodiments of the present disclosure pertain.

The terms “a,” “an,” and “the” include both singular and plural referents.

The term “or” is synonymous with “and/or” and means any one member or combination of members of a particular list.

As used herein, the term “exemplary” refers to an example, an instance, or an illustration, and does not indicate a most preferred embodiment unless otherwise stated.

The term “about” as used herein refers to slight variations in numerical quantities with respect to any quantifiable variable. Inadvertent error can occur, for example, through use of typical measuring techniques or equipment or from differences in the manufacture, source, or purity of components.

The term “substantially” refers to a great or significant extent. “Substantially” can thus refer to a plurality, majority, and/or a supermajority of said quantifiable variables, given proper context.

The term “generally” encompasses both “about” and “substantially.”

The term “configured” describes structure capable of performing a task or adopting a particular configuration. The term “configured” can be used interchangeably with other similar phrases, such as constructed, arranged, adapted, manufactured, and the like.

Terms characterizing sequential order, a position, and/or an orientation are not limiting and are only referenced according to the views presented.

The “scope” of the present disclosure is defined by the appended claims, along with the full scope of equivalents to which such claims are entitled. The scope of the disclosure is further qualified as including any possible modification to any of the aspects and/or embodiments disclosed herein which would result in other embodiments, combinations, subcombinations, or the like that would be obvious to those skilled in the art.

The present disclosure is not to be limited to that described herein. Mechanical, electrical, chemical, procedural, and/or other changes can be made without departing from the spirit and scope of the present disclosure. No features shown or described are essential to permit basic operation of the present disclosure unless otherwise indicated.

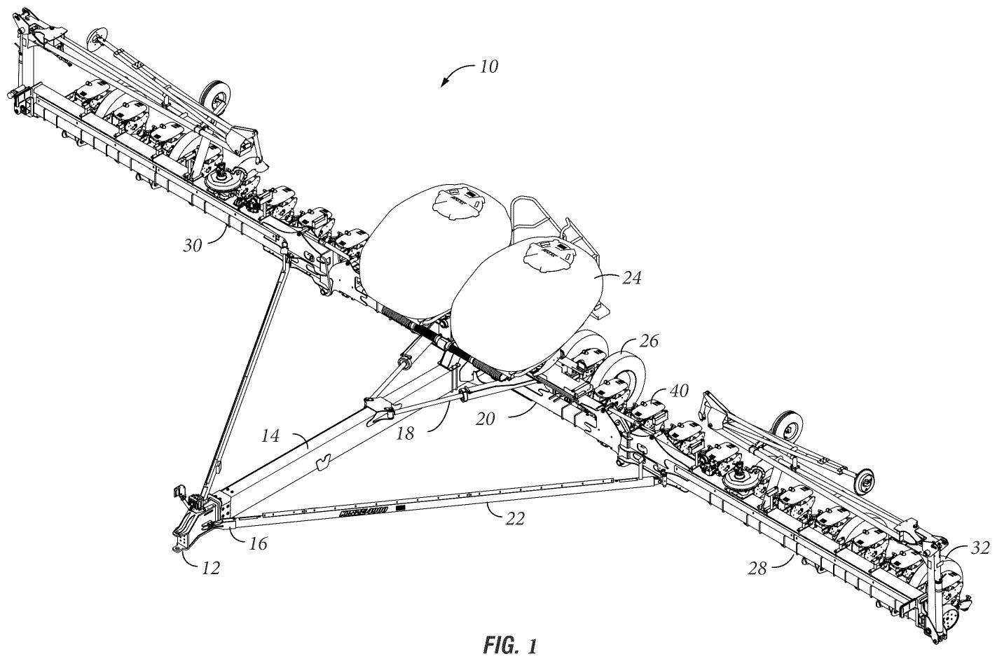

FIG. 1 shows an agricultural implement in the form of an agricultural planter 10 used to plant and fertilize seed in a controlled manner. The planter 10 as shown in FIG. 1 includes a tongue 14, which may be telescoping. The tongue 14 includes a first end 16 with an implement hitch 12 for attaching to a tow vehicle, such as a tractor, prime mover, or other vehicle. The opposite end 18 of the tongue 14 is attached to a toolbar 20. Draft links 22 are shown to be connected between the toolbar 20 and the tongue 14 and are used in conjunction with folding actuators to fold the toolbar 20 in a frontward manner. The tongue 14 maybe a telescoping tongue in that it can extend or retract to allow for the front folding of the toolbar 20. The planter 10 may also be a lift and rotate, rear fold, vertical fold, narrow row, or generally any other type of planter.

In addition, as noted, the implement may be a different type of ground engaging implement. For example, agricultural sprayers, plows, tillage equipment, seeders, drills, fertilizers, or other types of implements that can utilize the novel features disclosed herein should be considered a part of the disclosure.

The toolbar 20 includes first and second wings extending generally outwardly therefrom. The toolbar 20 includes central hoppers 24, which contain seed or other granules/particulate used with ground engaging tools, such as seed for planting. A plurality of transport wheels 26 also are connected to the toolbar 20. The first and second wings are generally mere images of one another in mirrored fashion. The wings include first and second wing toolbars, which are essentially extensions from a central toolbar portion. Attached along the toolbar 20 as well as the first and second wing are a plurality of row units 40. When the implement is a planting unit, the row units will include seed meters, ground engaging tools, and/or other components used for planting, tilling, and fertilizing seed in a controlled manner, such as many components that will be described in more detail herein. Also connected to the first and second wings are first and second markers. The markers include actuators, which are used to raise and lower the markers. The markers can be lowered to provide guidance for the edge of a planter for use in planting. When not required, the markers can be lifted to a position as that shown in FIG. 1 to move the markers out of the way.

Also shown in FIG. 1 are a plurality of fans as well as a plurality of wheels 32. The wings may also include actuators to raise and lower or otherwise provide a downward force on the wings. Therefore, as is shown in FIG. 1, there are a multiplicity of components of the planting implement 10. The components may include moving parts, such as the actuators used to move the wings, markers, row units, etc., while also providing additional functions. For example, the fans are used to provide a pressure in the seed meters to aid in adhering seed to a seed disk moving therein. The seed meters may be electrically driven in that a motor, such as a stepper motor, can be used to rotate the seed meters to aid in adhering seed thereto and to provide for dispensing of the seed in a controlled manner for ideal spacing, population, and/or placement. Other features may include actuators or other mechanisms for providing down force to the row units 40. Lights may also be included as part of the planter.

Additionally, an air seed delivery system may be provided between the central hoppers 24 and any plurality of seed meters on the row units 40 in that the air seed delivery system provides a continued flow of seed to the row units on an as needed manner to allow for the continuous planting of the seed via the seed meters on the row units. Thus, the various controls of the planter may require or otherwise be aided by the use of an implement control system. The implement control system can aid in controlling each of the functions of the implement or planter 10 so as to allow for the seamless or near seamless operation with the implement, and also provides for the communication and/or transmission of data, status, and other information between the components.

As will be appreciated, the planter need not include all of the features disclosed herein and may also include additional or alternative features as those shown and/or described. The foregoing has been included as an exemplary planter, and it should be appreciated that generally any planter from any manufacturer and any add-ons or aftermarket components may be included in any planter that encompasses any of the aspects of the invention.

A planter 10 such as that shown, can be pulled by the tow vehicle, such as the tractor. In addition, the planter 10 could be pulled by or itself be a self-propelled, autonomous tug unit, rather than an operator-driven vehicle, such as the tractor, such as the one shown and described in co-owned U.S. Pat. No. 10,575,453, which is herein incorporated by reference in its entirety. The rear drivable wheels and front steerable wheels can be substituted for tracks, regardless of whether said tracks are implemented on an operator-driven vehicle or a self-propelled vehicle.

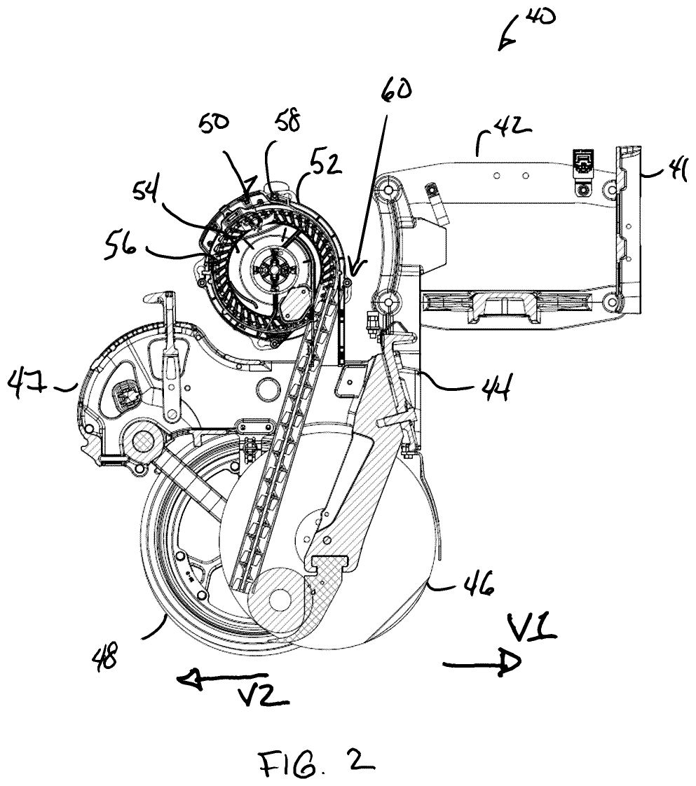

An example of a row unit 40 including aspects and/or embodiments of the present disclosure is shown in FIG. 2. The row unit 40 is a unit that includes ground engaging elements for the agricultural implement 10. For example, the row unit 40 shown in FIG. 2 includes components for planting seeds. As noted, a plurality of row units 40 are spaced along the toolbar 20 of the implement 10. The spacing of the row units 40 accounts for the desired spacing for rows of seeds that will be planted with the unit. The figures show the row units 40 to be pull-type units that are positioned behind the toolbar 20, but it should be appreciated that many of the components will be able to be used on push-type units that are positioned on the front side of the toolbar 20 as well.

Components of the exemplary row unit 40 shown in FIG. 2 include a faceplate 41 that is used to mount the row unit 40 to the toolbar 20. The faceplate 41 can be any component that will allow a mechanical connection, such as via mechanical fasteners, between the row unit 40 and the toolbar 20. In general, a mechanical fastener is a device that is used to mechanically join or fasten two or more objects together. In general, fasteners are used to create non-permanent joints or connections; that is, joints that can be removed or dismantled without damaging the joining components. General types of mechanical fasteners can include threaded (bolts, screws, nuts, studs, etc.) or non-threaded (keys, pins, retaining rings, etc.). Additional fasteners can include, but are not limited to nails, rivets, and the like. Non-mechanical fasteners may include adhesives, fittings, clearance fittings, friction fittings, compression fittings, transition fittings, snaps, snap fits, hook and loops, joints, and the like. For simplistic purposes, screws, nuts, bolts, pins, rivets, staples, washers, grommets, latches (including pawls), ratchets, clamps, clasps, flanges, ties, adhesives, welds, any other known fastening mechanisms, or any combination thereof may be used to facilitate fastening, may be used for any of the connections described herein and all are to be considered swappable with one another for any of the attachment, connection, and/or fastening of components, either temporarily or permanently. It is further considered that any combination of any of the listed mechanical and/or non-mechanical fasteners or methods of fastening are to be considered a part of the disclosure.

In addition, the faceplate 41 can include U or C-shaped fasteners that will attach to the faceplate and surround a portion of the toolbar for mounting. However, the exact manner of fastening should not be limiting to the disclosure.

Extending from the faceplate 41 is a linkage system 42, which is shown to be a four bar linkage. The linkage system 42 includes rotatable fasteners at both ends that allow the linkage arms to rotate and move. This allows the row unit to move in a generally vertical manner relative to the toolbar, such as due to the elevation changes in a field. Attached at a rear location of the linkage 42 is a frame 44. The frame can be cast or otherwise and is a mount for many of the components of the row unit 40. In other words, the frame 44 provides structural integrity for the components.

At a lower end of the frame 44 are opening wheels 46, which are also known as coulter wheels. The opener wheels 46 are used to create a furrow in the field in which the seed is deposited for planting. Behind the coulter wheels 46 are gauge wheels 48, which aid in setting the desired depth of furrow created by the coulter wheels 46. The gauge wheels 48 can be connected to a depth setting system, such as that shown in U.S. Ser. No. 17/813,982, filed Jul. 21, 2022, which is hereby incorporated by reference in its entirety. Also shown in part is a closing system 47. The closing system will include closing wheels (not shown) that will close the furrow created by the coulter wheels 46 after the seed has been deposited.

To plant the seeds in the desired population, spacing, and other factors, a seed meter 50 is included to meter seeds. The seed meter 50 can take many forms, including air seed meter (vacuum or positive pressure), or a mechanical type of meter (e.g., finger meter). For example, the meter may take the form of any of the embodiments shown in U.S. Pat. Nos. 10,842,072; 11,716,925, or any of their related patent applications and patents, all of which are hereby incorporated by reference in their entirety. The exact type of seed meter is not to be limiting or dispositive on the present disclosure.

The seed meter 50 generally will include a seed meter housing 52 and a seed disc 54 rotating therein. The seed disc 54 includes a number of seed cells 56 that correspond to a type of seed to be planted via the system. Seed will be provided to the seed meter 50 either from one or more bulk hoppers or from hoppers that are positioned directly at the row unit 40. The seed is collected in the housing and the disc 54 rotates to “pick up” seed at the seed cells. The seeds are generally passed through a singulator 58, which attempts to control the number of seed at a seed cell 56. For example, it is desired to have a single corn seed at each seed cell 56 and the singulator 58 will attempt to ensure this. The disc 54 will continue to rotate to a location where the seed will be released, dislodged, or otherwise removed from the disc 54 to direct the seed towards the furrow in the field created by the coulter wheels 46.

To further aid in the control of seed placement in the field, and also to accommodate higher planting speeds (e.g., planting up to 15 miles per hour or less), a seed to ground system 60 is shown adjacent the seed meter 50. As will be understood, the seed to ground system 60 is an assembly that will take seed from the seed meter 50 and to deliver the seed therefrom at the ground in a manner that will dispense seed with a net zero relative horizontal velocity with respect to the travel speed of the implement 10. This will mitigate rolling or bouncing of seed that is dispensed into the furrow, which will control the spacing of the seed in the furrow at generally any speed, including the higher speeds of planting. Planting at higher speeds will allow the planting time to decrease, ensuring that the seed is planted within a desired climate window corresponding to the seed type.

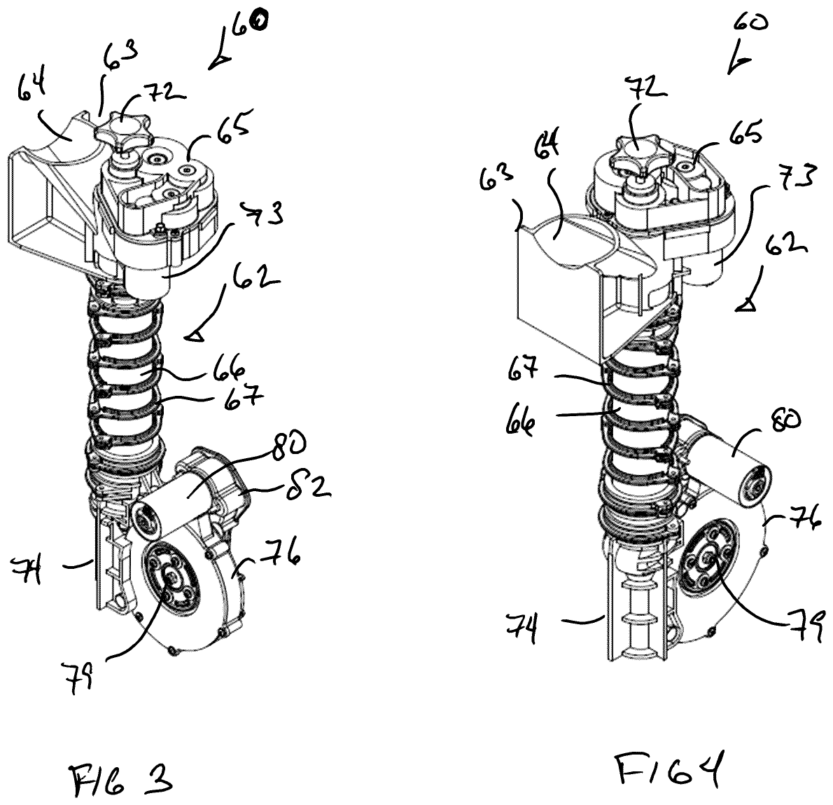

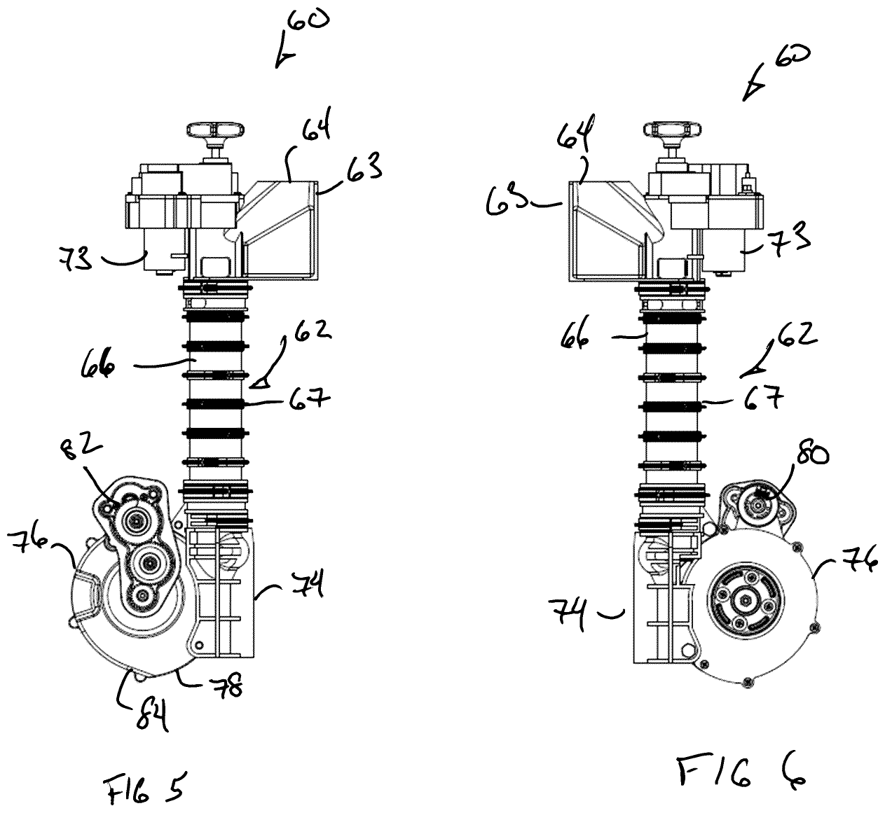

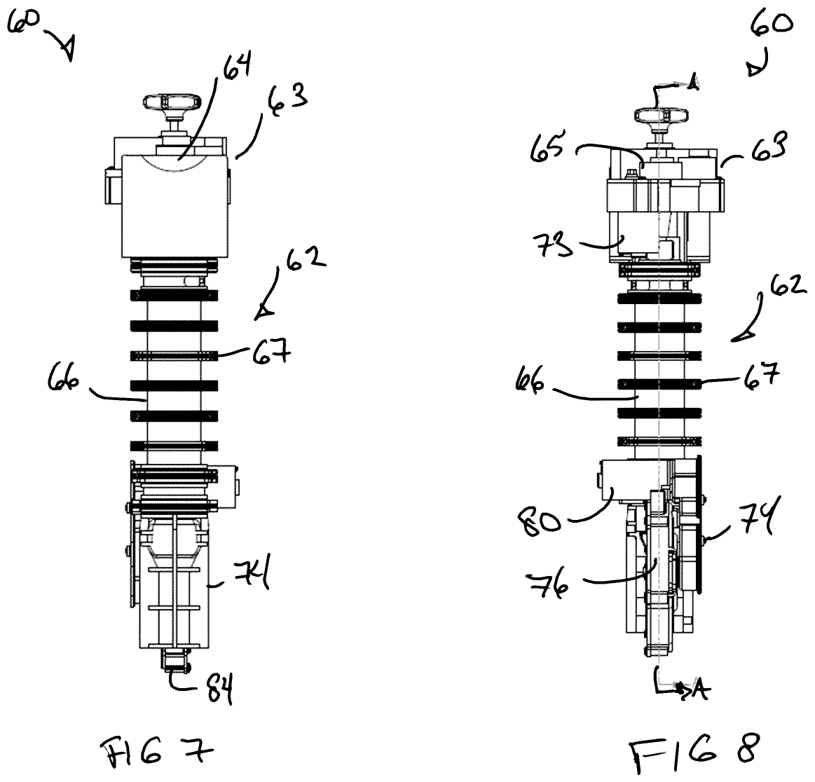

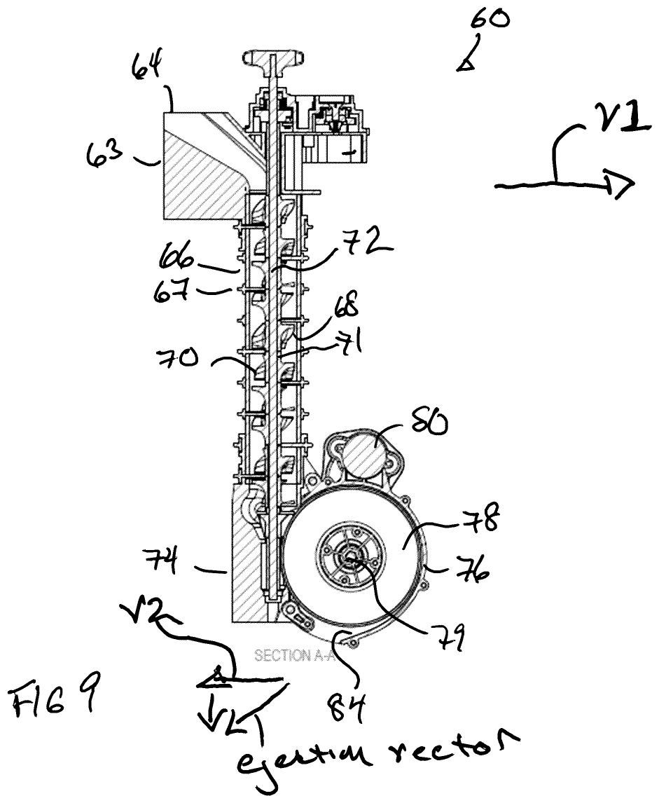

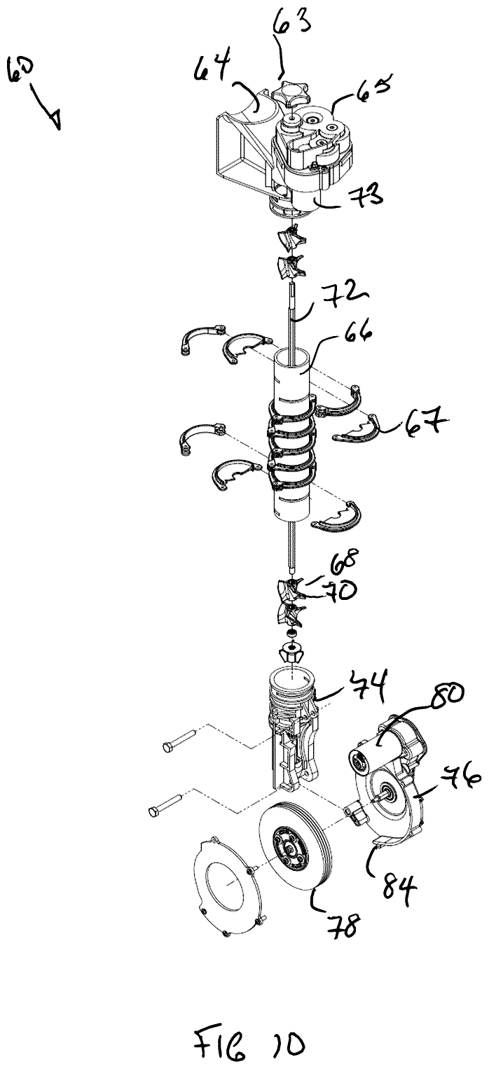

As shown in FIG. 2, and then in greater detail in FIGS. 3-10, the seed to ground system according to aspects and/or embodiments of the present disclosure is positioned adjacent to the seed meter 50 to receive seed that has been metered by the system.

The seed to ground system 60 includes a housing 62 with an upper end 63 that is adjacent to the seed meter 50, and particularly adjacent the discharge location of the seed meter housing 52. Seed will enter the seed to ground system 60 at an opening 64 of the upper end 63. The opening 64 is shown to be a chute or ramp-like member to direct seed into the housing 62 of the seed to ground system 60 (see, e.g., FIG. 9 showing the opening as a ramp like member).

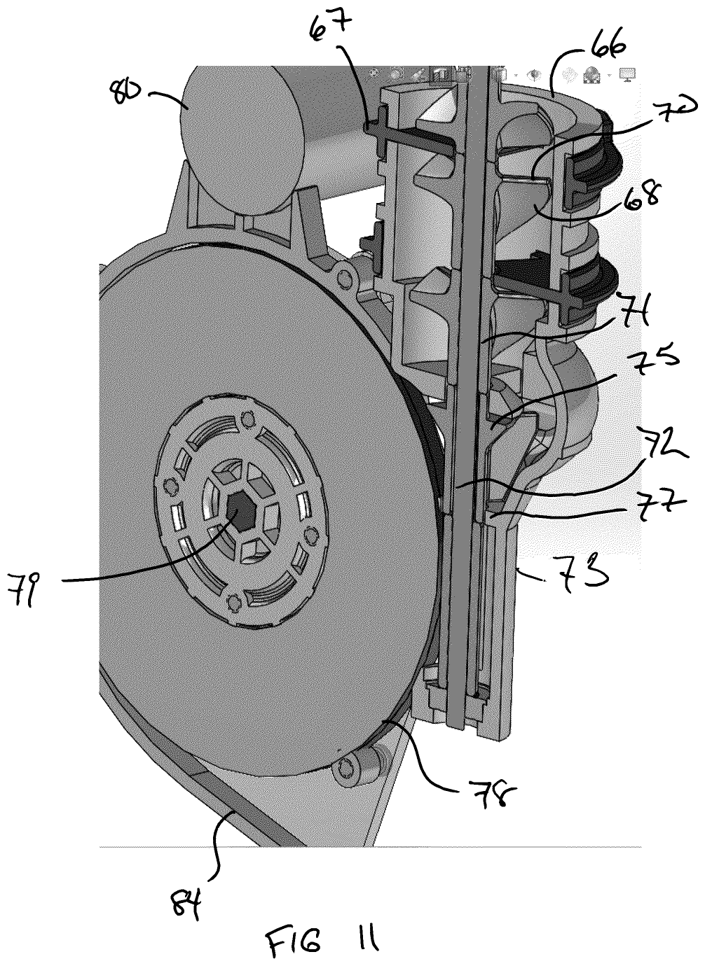

The housing 62 of the seed to ground system 60 further includes a chute section 66 extending downwardly from the upper end 63, which culminates in a lower section 74. The chute 66 includes a cylinder like member (see, e.g., FIG. 10) that includes cutout or notches therein. A driven shaft 72 also extends in the chute 66. The shaft 72 is connected to a drive motor 73. The shaft 72 can be directly connected to the motor 73 or can be connected via one or more gears 65 to aid in controlling the rotational velocity of the shaft 72. The drive motor can be any motor, including, but not limited to an electric motor (e.g., brushless DC motor). However, this is not to be limiting to the invention or disclosure and generally any type of electric or non-electric drive member/motor can be utilized and considered a part of the present disclosure. Still further, one skilled in the art may appreciate that the motor could also derive its power from a pneumatic or hydraulic rotary motor, as well as any other type of rotary motion, including but not limited to, mechanical, cable drive, or chain.

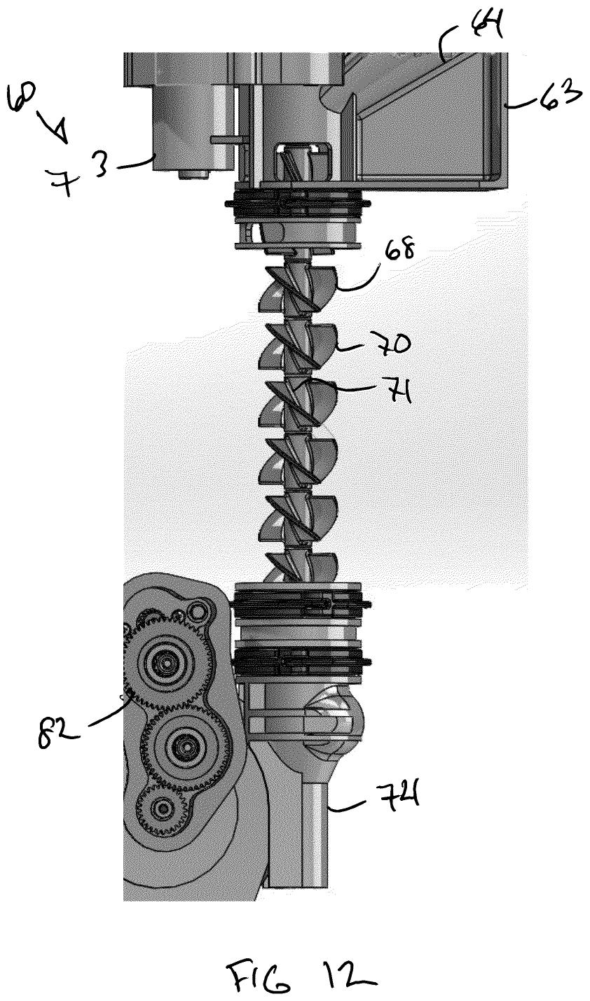

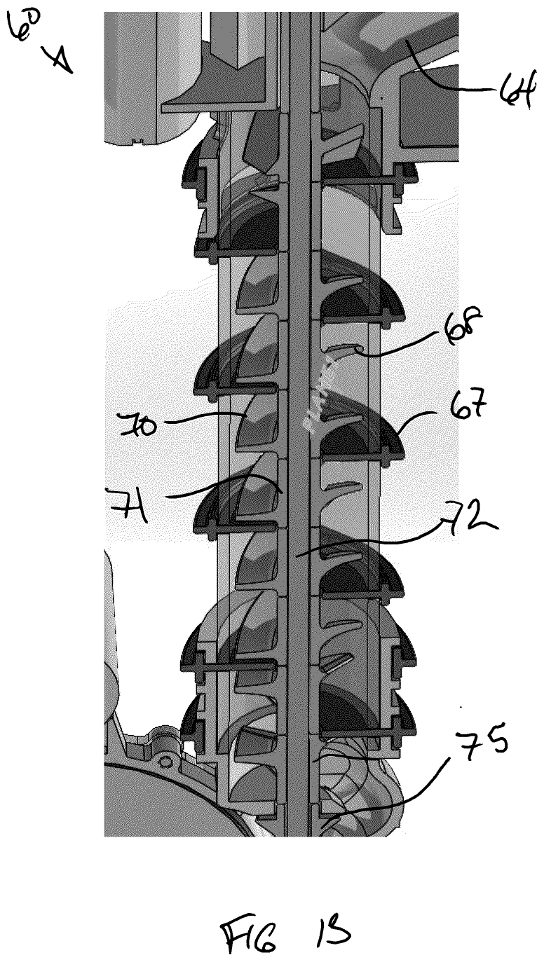

Positioned within the chute 66 and operatively connected to the driven shaft 72 are one or more impeller members or sections 68. The impellers 68 include impeller flighting 70 comprising a spiral ramp around an impeller shaft section 71 (see, e.g., FIGS. 11 and 12). The flighting 70 may be continuous in angle or may include a steeper portion at or near the lower end of the impeller 68, which aids in moving the seeds from the floors while mitigating shearing of a seed positioned thereon. However, it should be noted that any angle of flighting capable of moving the seeds will be considered to be a part of the present disclosure. While a plurality of impellers 68 are shown in the figures, it should also be appreciated that a single impeller with flighting extend from the upper end 63 to the lower end 74 of the housing 62 as well. Furthermore, it is noted the impellers 68 could also be referred to as auger like sections or auger sections, which include an inclined portion wrapped around an axis.

The impellers 68 are attached to the shaft 72 such that the impellers 68 will rotate correspondingly with the shaft 72, which is being controlled by the motor 73 and/or gears 65. According to at least some embodiments, the shaft 72 and impellers 68 will rotate with a speed that corresponds to the rotational speed of the seed disc 54 in the meter 50. Therefore, there will be seamless passing from the seed meter 50 to the seed to ground system 60 via the opening 64 at the upper end 63. The seeds moved into the seed to ground system will move along the impeller flighting 70 as the impellers 68 rotate.

In addition, it is noted that there are a plurality of floor sections 67 positioned in the chute 66 of the housing 62 of the seed to ground system 60. The floors 67 are substantially horizontal members relative to the axis of the chute 62 such that they bisect a portion of the chute. The floors 67 may be positioned through the slots or notches in the chute and spaced vertically from one another. According to at least some aspects of some embodiments, the floors 67 are positioned between corresponding impellers 68 in the chute 66. The floors 67 can be held in place by a mechanical or non-mechanical fastener, which allows for easy adding and removal of the floors.

The floors 67 will work with the impellers 68 to control the movement of the seed through the chute 66 of the seed to ground system 60. Once the seed has entered the system 60 via the opening 64, the seed will encounter an uppermost impeller 68 that is rotating according to the seed meter rotation. The flighting 70 of the impeller 68 will move the seed towards the first floor section 67 (i.e., the uppermost floor section in FIG. 9). The seed would rest on the floor 67 but for the rotational impeller 68 moving the seed to a location where the floor 67 does not extend into the chute 66. The seed will be able to fall into the next impeller 68 and onto the next floor 67. The continued rotation of the impellers 68 will continue to move the seed from one floor to the next until the seed reaches the lower end of the chute 66.

The lower end of the chute 66 terminates into a lower end 74 of the housing 62 of the seed to ground system 60. At the lower end 74 resides a lower most impeller 75 and a lowermost floor section 77. The seed will rest on the lowermost floor section 77 until the lowermost impeller 75 rotates the seed towards a dispensing wheel 78 in a wheel housing 76 at the lower portion of the seed to ground system 60.

As shown in the figures, the dispensing wheel 78 is positioned in a housing 76 and rotates about an axis 79 therein. A wheel motor 80 is operatively connected to the wheel 78 either directly or via one or more gears 82. The wheel motor may also be an electric motor, such as a DC brushless motor, a stepper motor, or any other type of motor to provide the rotational movement to the wheel and/or gears.

The wheel 78 comprises a brush wheel or a resilient material that is able to hold and move seed in the housing 76, as the wheel rotates about its axis 79. For example, when the wheel 78 comprises a brush wheel (e.g., a wheel with an axis that is surrounded by a plurality of outwardly facing bristles), the rotational movement of the lowermost impeller 75 will push the seed into the bristles as the wheel 78 rotates. The bristles will hold the seed as the wheel 78 rotates to an ejection location or ramp 84, which will dispel the seed from the housing. Likewise, if the wheel comprises a resilient member, the seed can be positioned between the outer portion of the resilient wheel and the housing by the lowermost impeller 75 from the lowermost floor 77 and the rotating wheel will move the seed in the housing to the ejection ramp 84.

The motor 80 will rotate the wheel 78 is a rotational velocity to substantially match the moving velocity of the planting implement 10. It is noted that this will likely be much higher than that of the rotational velocities of the seed disc in the meter and the impellers 68 in the chute. Therefore, the movement of the lowermost impeller 75 to push the seed into the wheel 78 will be done in a manner where the opening is smaller to ensure that the seed is urged into the proper location in the wheel 78 (see, e.g., FIG. 11). Note in FIG. 11 that the lowermost impeller 75 is sandwiched between floor sections to mitigate the seed from not entering the wheel by the moving impeller. This is done, in part, by narrowing the diameter of the lower end of the system 60 at the lowermost impeller 75.

As noted, once the seed is in the wheel 78 and/or housing 76, it will be sped up to account for the speed of the moving implement 10, which may be up to 15 mph. The higher rotational speeds will be necessary to eject the seed from the housing 76 such that a horizontal velocity component of the ejecting seed will essentially match the opposite horizontal velocity of the planting implement 10.

Put another way, it is noted that the planting implement 10 will be moving in a first direction. This direction will have a horizontal velocity component, which will be referred to as V1. In FIG. 9, this would be an arrow pointing to the right of the page. As shown in the figure, the ejection ramp 84 of the seed to ground system 60 is oriented downward and to the left of the page. This means that the rotation of the wheel 78 will eject the seed in a direction that is generally angled down and to the left as shown in FIG. 9 (i.e., an angled vector).

As is known, angled vectors include both a horizontal and a vertical component. Therefore, knowing the angle of ejection will allow the speed of the wheel 78 to be set to have the horizontal component (which we will call V2) of the ejection vector of the seed substantially match V1 from the planter. This will result in a net zero horizontal velocity (V1=V2) for the ejecting seed as it is released into the furrow, which will mitigate any bouncing or rolling of the seed in the furrow.

Because the speed of the planting implement will be known, a controller can be used to manage the rotational speed of the wheel 78 to attempt to match V1 and V2, regardless of the speed of the planter 10. In addition, the controller will be able to manage the speed of the seed meter and impellers to ensure that the spacing between subsequent seeds can be maintained and set according to the desired agronomic spacing.

The controller can be found in a display unit or other computer or computer readable medium on the planter or a tow vehicle. In communications and computing, a computer readable medium is a medium capable of storing data in a format readable by a mechanical device. The term “non-transitory” is used herein to refer to computer readable media (“CRM”) that store data for short periods or in the presence of power such as a memory device.

One or more embodiments described herein can be implemented using programmatic modules, engines, or components. A programmatic module, engine, or component can include a program, a sub-routine, a portion of a program, or a software component or a hardware component capable of performing one or more stated tasks or functions. A module or component can exist on a hardware component independently of other modules or components. Alternatively, a module or component can be a shared element or process of other modules, programs, or machines.

The controller (such as a display unit) will preferably include an intelligent control (i.e., a controller) and components for establishing communications. Examples of such a controller may be processing units alone or other subcomponents of computing devices. The controller can also include other components and can be implemented partially or entirely on a semiconductor (e.g., a field-programmable gate array (“FPGA”)) chip, such as a chip developed through a register transfer level (“RTL”) design process.

A processing unit, also called a processor, is an electronic circuit which performs operations on some external data source, usually memory or some other data stream. Non-limiting examples of processors include a microprocessor, a microcontroller, an arithmetic logic unit (“ALU”), and most notably, a central processing unit (“CPU”). A CPU, also called a central processor or main processor, is the electronic circuitry within a computer that carries out the instructions of a computer program by performing the basic arithmetic, logic, controlling, and input/output (“I/O”) operations specified by the instructions. Processing units are common in tablets, telephones, handheld devices, laptops, user displays, smart devices (TV, speaker, watch, etc.), and other computing devices.

The memory includes, in some embodiments, a program storage area and/or data storage area. The memory can comprise read-only memory (“ROM”, an example of non-volatile memory, meaning it does not lose data when it is not connected to a power source) or random access memory (“RAM”, an example of volatile memory, meaning it will lose its data when not connected to a power source). Examples of volatile memory include static RAM (“SRAM”), dynamic RAM (“DRAM”), synchronous DRAM (“SDRAM”), etc. Examples of non-volatile memory include electrically erasable programmable read only memory (“EEPROM”), flash memory, hard disks, SD cards, etc. In some embodiments, the processing unit, such as a processor, a microprocessor, or a microcontroller, is connected to the memory and executes software instructions that are capable of being stored in a RAM of the memory (e.g., during execution), a ROM of the memory (e.g., on a generally permanent basis), or another non-transitory computer readable medium such as another memory or a disc.

Generally, the non-transitory computer readable medium operates under control of an operating system stored in the memory. The non-transitory computer readable medium implements a compiler which allows a software application written in a programming language such as COBOL, C++, FORTRAN, or any other known programming language to be translated into code readable by the central processing unit. After completion, the central processing unit accesses and manipulates data stored in the memory of the non-transitory computer readable medium using the relationships and logic dictated by the software application and generated using the compiler.

In one embodiment, the software application and the compiler are tangibly embodied in the computer-readable medium. When the instructions are read and executed by the non-transitory computer readable medium, the non-transitory computer readable medium performs the steps necessary to implement and/or use the present invention. A software application, operating instructions, and/or firmware (semi-permanent software programmed into read-only memory) may also be tangibly embodied in the memory and/or data communication devices, thereby making the software application a product or article of manufacture according to the present invention.

The database is a structured set of data typically held in a computer. The database, as well as data and information contained therein, need not reside in a single physical or electronic location. For example, the database may reside, at least in part, on a local storage device, in an external hard drive, on a database server connected to a network, on a cloud-based storage system, in a distributed ledger (such as those commonly used with blockchain technology), or the like.

Finally, as noted, the controls may be part of a user interface. A user interface is how the user interacts with a machine. The user interface can be a digital interface, a command-line interface, a graphical user interface (“GUI”), oral interface, virtual reality interface, or any other way a user can interact with a machine (user-machine interface). For example, the user interface (“UI”) can include a combination of digital and analog input and/or output devices or any other type of UI input/output device required to achieve a desired level of control and monitoring for a device. Examples of input and/or output devices include computer mice, keyboards, touchscreens, knobs, dials, switches, buttons, speakers, microphones, LIDAR, RADAR, etc. Input(s) received from the UI can then be sent to a microcontroller to control operational aspects of a device.

The user interface module can include a display, which can act as an input and/or output device. More particularly, the display can be a liquid crystal display (“LCD”), a light-emitting diode (“LED”) display, an organic LED (“OLED”) display, an electroluminescent display (“ELD”), a surface-conduction electron emitter display (“SED”), a field-emission display (“FED”), a thin-film transistor (“TFT”) LCD, a bistable cholesteric reflective display (i.e., e-paper), etc. The user interface also can be configured with a microcontroller to display conditions or data associated with the main device in real-time or substantially real-time.

Still additional components of the seed to ground system 60, such as shown in FIG. 11 include bearings and bushings, which aid in the rotation of the shaft 72 in the housing 62, and also in the lower end 73 thereof. The same bearings and/or bushings may be found in the upper end 63 of the housing 62.

Therefore, a seed to ground system has been shown and described that improves on existing systems and provides a controlled manner to eject seeds from a planter moving at high speeds. It should be noted that any of the components of any of the aspects and/or embodiments provided can be combined with other components, even if not explicitly disclosed, to create yet additional embodiments that are within the scope of the present disclosure. In addition, variations and alternatives obvious to those skilled in the art are to be considered a part of the present disclosure.

1. An agricultural planting implement, comprising:
a plurality of row units, each of the plurality of row units including:
a seed meter; and
a seed to ground system, the seed to ground system comprising:
a housing with an upper end to receive seed from the seed meter and a lower end;
one or more impellers rotatably mounted in the housing;
one or more vertically spaced floors in the housing; and
a delivery wheel at the lower end of the housing to receive seed and to eject seed with zero net horizontal velocity.

2. The agricultural planting implement of claim 1, wherein the one or more vertically spaced floors extend substantially perpendicular to an axis of the one or more impellers.

3. The agricultural planting implement of claim 1, wherein the one or more vertically spaced floors are positioned between sections of the one or more impellers.

4. The agricultural planting implement of claim 1, wherein the one or more impellers comprises sections, and each section comprises a portion of an impeller flighting around a center shaft.

5. The agricultural planting implement of claim 1, further comprising an impeller motor operatively connected to the one or more impellers to provide rotation thereto, the impeller motor comprising an electric motor.

6. The agricultural implement of claim 1, further comprising a wheel motor operatively connected to the delivery wheel, the wheel motor comprising an electric motor.

7. The agricultural implement of claim 1, wherein the delivery wheel comprises a brush wheel.

8. The agricultural implement of claim 1, wherein the wheel comprises a resilient material.

9. The agricultural implement of claim 1, further comprising a wheel housing extending from the housing of the seed to ground system and covering a portion of the delivery wheel.

10. The agricultural implement of claim 9, wherein the wheel housing includes a discharge ramp for ejecting the seed.

11. A row unit for use with an agricultural implement, comprising:
a seed meter;
a seed to ground system adjacent the seed meter and comprising a housing having an upper end to receive seed from the seed meter, a plurality of impellers and one or more floors in the housing, and a delivery wheel at a lower end of the housing to move seed from the housing to a furrow in a field.

12. The row unit of claim 11, wherein the one or more floors in the housing are vertically spaced from one another.

13. The row unit of claim 11, wherein the one or more floors are positioned between the plurality of impellers.

14. The row unit of claim 11, further comprising an impeller motor operatively connected to the plurality of impellers to provide rotation thereto, the impeller motor comprising an electric motor.

15. The row unit of claim 14, further comprising a shaft connected to the impeller motor, and wherein the plurality of impellers are mounted on the shaft for rotation.

16. The row unit of claim 11, wherein the delivery wheel comprises a brush wheel.

17. The row unit of claim 16, wherein the brush wheel is operatively connected to an electric wheel motor.

18. The row unit of claim 11, further comprising a sensor in the housing.
